(19) United States
(12) Patent Application Publication
(10) Pub. No.: US 2025/0144977 A1
(43) Pub. Date: May 8, 2025

(54) VEHICULAR HEAT MANAGEMENT SYSTEM

(71) Applicant: Hanon Systems, Daejeon (KR)

(72) Inventors: Chang Soo BAE, Daejeon (KR); Dong Gyun KIM, Daejeon (KR); Chan Joo MAENG, Daejeon (KR); Tae Yeong PARK, Daejeon (KR); Gyu Ik HAN, Daejeon (KR); Heon HUR, Daejeon (KR)

(21) Appl. No.: 18/832,135

(22) PCT Filed: Feb. 28, 2023
(86) PCT No.: PCT/KR2023/002800

§ 371 Date: Jul. 23, 2024

(30) Foreign Application Priority Data
Mar. 17, 2022 (KR) 10-2022-0033405

(51) Int. Cl. B60H 1/32

(52) U.S. Cl. CPC B60H 1/3228

(57) ABSTRACT

A vehicular heat management system includes a refrigerant circulation line including a compressor, a high pressure side heat exchanger, a heat pump mode expansion valve, an outdoor heat exchanger, and a plurality of low pressure side heat exchangers installed parallel to each other. The refrigerant circulation line further includes a refrigerant pipe having an increased diameter portion formed by increasing the diameter of a specific refrigerant pipe portion among a plurality of refrigerant pipe portions affecting a refrigerant pressure in the refrigerant pipe portions on the intake and discharge sides of the compressor so that the specific refrigerant pipe portion has a larger diameter than other refrigerant pipe portions.

### TECHNICAL FIELD

The present invention relates to a vehicular heat management system and, more particularly, to a vehicular heat management system configured to reduce a refrigerant pressure loss on the intake and discharge sides of a compressor and capable of preventing a decrease in the compressor's work output due to the refrigerant pressure loss on the intake and discharge sides of the compressor, thereby improving the cooling performance of an air conditioning system.

### BACKGROUND ART

Examples of an eco-friendly vehicle include an electric vehicle, a hybrid vehicle, and a fuel cell vehicle (hereinafter collectively referred to as “vehicle”).

Such a vehicle is equipped with an air conditioning system 10 for cooling and heating a passenger room as shown in FIG. 1.

The air conditioning system 10 is of a heat pump type and is provided with a refrigerant circulation line 12.

The refrigerant circulation line 12 includes a compressor 12a, a high pressure side heat exchanger 12b, a heat pump mode expansion valve 12c, a water-cooled outdoor heat exchanger 12d, an air-cooled outdoor heat exchanger 12e, a plurality of air conditioner mode expansion valves 12f installed in parallel with each other, and a plurality of low pressure side heat exchangers 12g installed downstream of the respective air conditioner mode expansion valves 12f.

The low pressure side heat exchangers 12g include a heat exchanger used for cooling the front seat section of the passenger room, a heat exchanger used for cooling the rear seat section of the passenger room, and a heat exchanger that serves as a battery chiller for cooling a battery B. Hereinafter, among the low pressure side heat exchangers 12g, the heat exchanger installed relatively close to the compressor 12a is called a front seat low pressure side heat exchanger 12g-1, the heat exchanger installed relatively far from the compressor 12a is called a rear seat low pressure side heat exchanger 12g-2, and the remaining heat exchanger is called a battery chiller 12g-3.

This refrigerant circulation line 12 opens the heat pump mode expansion valve 12c in an air conditioner mode, so that the refrigerant in the compressor 12a is not depressurized and expanded by the heat pump mode expansion valve 12c and can be circulated in the order of the high pressure side heat exchanger 12b, the water-cooled outdoor heat exchanger 12d, the air-cooled outdoor heat exchanger 12e, the air conditioner mode expansion valve 12f, the low pressure side heat exchanger 12g, and the compressor 12a.

Through this refrigerant circulation, a low temperature cold air is generated in the low pressure side heat 12g, and is fed to the passenger room and the battery B to cool the passenger room and the battery B.

In addition, in the heat pump mode, the heat pump mode expansion valve 12c is turned on to allow depressurization and expansion of the refrigerant, so that the refrigerant in the compressor 12a is circulated in the order of the high pressure side heat exchanger 12b, the heat pump mode expansion valve 12c, the water-cooled outdoor heat exchanger 12d, and the compressor 12a.

Through this refrigerant circulation, a high temperature air is generated in the high pressure side heat exchanger 12b, and is supplied to the passenger room to heat the passenger room.

Meanwhile, the water-cooled outdoor heat exchanger 12d functions as an evaporator in the heat pump mode and also plays a role in allowing the refrigerant flowing therein to exchange heat with the coolant on the coolant circulation line 20 side for cooling an electrical component module P.

In particular, the coolant in the coolant circulation line 20 that has absorbed the waste heat of the electrical component module P is allowed to exchange heat with the refrigerant of the water-cooled outdoor heat exchanger 12d.

Accordingly, the waste heat of the electrical component module P can be recovered to the refrigerant of the refrigerant circulation line 12, and as a result, the heat pump mode efficiency of the air conditioning system 10 can be increased.

The refrigerant circulation line 12 further includes a dehumidification line 14 branched from the downstream side of the rear end of the heat pump mode expansion valve 12c and connected to the upstream side of the front seat low pressure side heat exchanger 12g-1.

In the heat pump mode, the dehumidification line 14 introduces the refrigerant depressurized and expanded by the heat pump mode expansion valve 12c into the front seat low pressure side heat exchanger 12g-1.

Therefore, the front seat low pressure side heat exchanger 12g-1 can generate cold air. This makes it possible to remove moisture in the air blown into the passenger room in the heat pump mode.

However, this conventional heat management system has a disadvantage in that the length of the refrigerant circulation line 12 becomes longer due to the plurality of low pressure side heat exchangers 12g. Due to this disadvantage, a pipe resistance increases, resulting in an increase in the pressure loss of the refrigerant. Thus, the cooling performance of the air conditioning system 10 is reduced.

In particular, since the rear seat low pressure side heat exchanger 12g-2 is installed relatively far from the compressor 12a, the length of a refrigerant pipe between the rear seat low pressure side heat exchanger 12g-2 and the intake port 12a-1 of the compressor 12a inevitably becomes longer. Due to the long refrigerant pipe, the pipe resistance increases, resulting in a refrigerant pressure loss.

Thus, the refrigerant that has lost pressure is sucked into the compressor 12a, so that the refrigerant pressure loss in the refrigerant pipes on the intake side and discharge side of the compressor 12a becomes very large. As a result, the work output of the compressor 12a is reduced, thereby reducing the cooling performance of the air conditioning system 10.

### DETAILED DESCRIPTION OF THE INVENTION

### Technical Task

In view of the problems inherent in the related art, it is an object of the present invention to provide a vehicular heat management system capable of improving the structure of a refrigerant pipe and consequently reducing a refrigerant pressure loss on the intake and discharge sides of a compressor due to the increased length of the refrigerant pipe.

Another object of the present invention is to provide a vehicular heat management system capable of reducing a refrigerant pressure loss on the intake and discharge sides of a compressor and consequently preventing a decrease in the work output of the compressor due to the refrigerant pressure loss on the intake and discharge sides of the compressor, thereby improving the cooling performance of an air conditioning system.

### Means to Solve the Task

In order to achieve these objects, there is provided a vehicular heat management system, including: a refrigerant circulation line including a compressor, a high pressure side heat exchanger, a heat pump mode expansion valve, an outdoor heat exchanger, and a plurality of low pressure side heat exchangers installed parallel to each other, wherein the refrigerant circulation line further includes a refrigerant pipe having an increased diameter portion formed by increasing the diameter of a specific refrigerant pipe portion among a plurality of refrigerant pipe portions affecting a refrigerant pressure in the refrigerant pipe portions on the intake and discharge sides of the compressor so that the specific refrigerant pipe portion has a larger diameter than other refrigerant pipe portions.

The increased diameter portion includes a first enlarged portion formed in a specific section of the refrigerant pipe of the refrigerant circulation line between the low pressure side heat exchangers and the compressor, and the first enlarged portion is formed so that the diameter of the refrigerant pipe portion on the intake port side of the compressor is larger than the diameter of the refrigerant pipe portions on the discharge port sides of the low pressure side heat exchangers.

The first enlarged portion is formed in a specific section of each of the refrigerant pipe portions between the low pressure side heat exchangers and the compressor that extends from the specific refrigerant pipe portion on the side of the low pressure side heat exchangers to an intake port of the compressor.

The refrigerant pipe portions on the discharge port sides of the low pressure side heat exchangers are joined at a confluence point, and the first enlarged portion is formed is a section extending from the confluence point to the intake port of the compressor.

The system further comprises: a connector configured to connect the refrigerant pipe portions on the side of the first enlarged portion to the refrigerant pipe portions on the side of the low pressure side heat exchangers, wherein the connector has first and second connection ports to which the refrigerant pipe portions on the side of the low pressure side heat exchangers are connectable, and a third connection port to which the refrigerant pipe portion on the side of the first enlarged portion is connectable.

The diameter of the refrigerant pipe in the first enlarged portion is Ø21 mm, and the diameter of the refrigerant pipe on the side of each of the low pressure side heat exchangers is Ø16 or Ø19 mm.

The low pressure side heat exchangers include two of a front seat low pressure side heat exchanger, a rear seat low pressure side heat exchanger, and a battery-cooling low pressure side heat exchanger.

The increased diameter portion further includes a second enlarged portion formed in a specific section of the refrigerant pipe of the refrigerant circulation line between a discharge port of the compressor and the high pressure side heat exchanger.

The second enlarged portion is formed in the entire section or a specific section of the refrigerant pipe between the discharge port of the compressor and the high pressure side heat exchanger, the system further comprises a dehumidification line branched from a rear end of the heat pump mode expansion valve and connected to the low pressure side heat exchangers, and the second enlarged portion is formed to have a larger diameter than a refrigerant pipe of the dehumidification line.

The increased diameter portion further includes a third enlarged portion formed in a specific section of the refrigerant pipe of the refrigerant circulation line between the high pressure side heat exchanger and the outdoor heat exchanger.

### Effect of the Invention

The third enlarged portion is formed in the entire section or a specific section of the refrigerant pipe between the high pressure side heat exchanger and the outdoor heat exchanger, the system further comprises a dehumidification line branched from a rear end of the heat pump mode expansion valve and connected to the low pressure side heat exchangers, and the third enlarged portion is formed to have a larger diameter than a refrigerant pipe of the dehumidification line.

According to the vehicular heat management system of the present invention, the increased diameter portion is formed in the refrigerant pipe portions on the intake and discharge sides of the compressor so that the refrigerant pipe portions on the intake and discharge sides of the compressor have a larger diameter than other portions, thereby reducing the refrigerant pipe resistance generated in the refrigerant pipe portions on the intake port and discharge port sides of the compressor.

In particular, regardless of the length of the refrigerant pipe, it is possible to reduce the pipe resistance of the refrigerant generated in the refrigerant pipe portions on the intake and discharge port sides of the compressor.

In addition, since the pipe resistance of the refrigerant generated in the refrigerant pipe portions on the intake and discharge port sides of the compressor can be reduced, it is possible to reduce the refrigerant pressure loss on the intake and discharge sides of the compressor due to the pipe resistance of the refrigerant.

In addition, since the refrigerant pressure loss on the intake and discharge sides of the compressor can be reduced, it is possible to prevent a decrease in the work output of the compressor due to the refrigerant pressure loss, thereby improving the cooling performance of the air conditioning system.

### BRIEF DESCRIPTION OF THE DRAWINGS

FIG. 1 is a view showing a conventional vehicular heat management system.

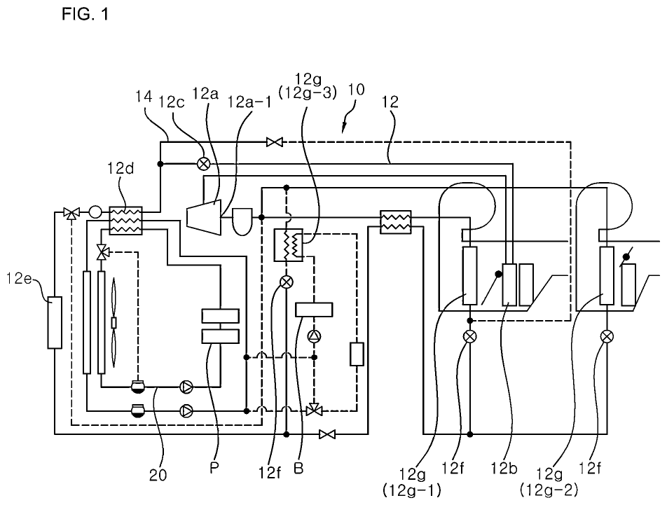

FIG. 2 is a view showing a vehicular heat management system according to the present invention.

FIG. 3 is a p-h diagram comparing an operation example of the vehicular heat management system according to the present invention with that of the vehicular heat management system of the related art.

### BEST MODE TO IMPLEMENT THE INVENTION

A preferred embodiment of a vehicular heat management system according to the present invention will now be described in detail with reference to the accompanying drawings (The same components as those of the conventional vehicular heat management system described above will be designated by like reference numerals).

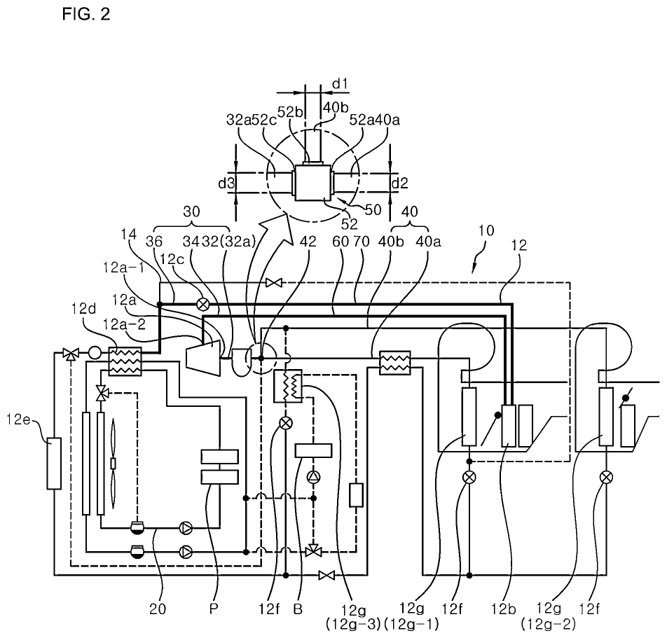

Prior to describing the features of the vehicular heat management system according to the present invention, the general configurations of the vehicular heat management system will be briefly described with reference to FIG. 2.

The vehicular heat management system includes an air conditioning system 10 provided with a refrigerant circulation line 12.

The refrigerant circulation line 12 includes a compressor 12a, a high pressure side heat exchanger 12b, a heat pump mode expansion valve 12c, a water-cooled outdoor heat exchanger 12d, an air-cooled outdoor heat exchanger 12e, a plurality of air conditioner mode expansion valves 12f installed in parallel with each other, and a plurality of low pressure side heat exchangers 12g installed downstream of the respective air conditioner mode expansion valves 12f, for example, a front seat low pressure side heat exchanger 12g-1, a rear seat low pressure side heat exchanger 12g-2, and a battery-cooling battery chiller 12g-3.

This refrigerant circulation line 12 opens the heat pump mode expansion valve 12c in an air conditioner mode.

Therefore, the refrigerant in the compressor 12a is not depressurized and expanded by the heat pump mode expansion valve 12c and can be circulated in the order of the high pressure side heat exchanger 12b, the water-cooled outdoor heat exchanger 12d, the air-cooled outdoor heat exchanger 12e, the air conditioner mode expansion valve 12f, the low pressure side heat exchanger 12g, and the compressor 12a.

Through this refrigerant circulation, low temperature cold air is generated in the low pressure side heat exchanger 12g, and is fed to the passenger room and the battery B to cool the passenger room and the battery B.

Meanwhile, the water-cooled outdoor heat exchanger 12d functions as an evaporator in the heat pump mode and also plays a role in allowing the refrigerant flowing therein to exchange heat with the coolant on the coolant circulation line 20 side for cooling an electrical component module P.

The refrigerant circulation line 12 further includes a dehumidification line 14 branched from the downstream side of the rear end of the heat pump mode expansion valve 12c and connected to the upstream side of the front seat low pressure side heat exchanger 12g-1.

In the heat pump mode, the dehumidification line 14 introduces the refrigerant depressurized and expanded by the heat pump mode expansion valve 12c into the front seat low pressure side heat exchanger 12g-1. Therefore, the front seat low pressure side heat exchanger 12g-1 can generate a cold air. The cold air thus generated can remove moisture in the air blown into the passenger room.

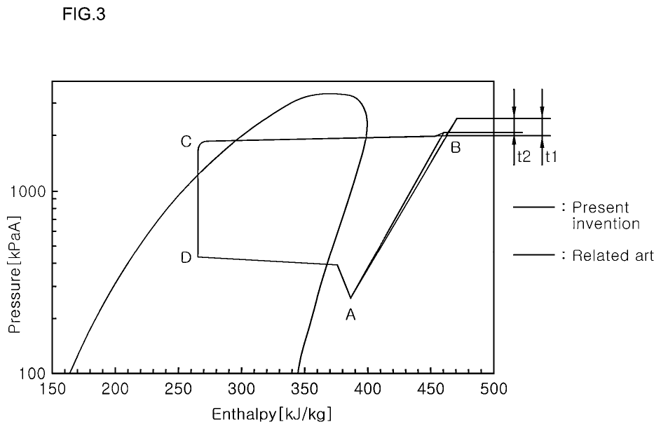

Next, the features of the vehicular heat management system according to the present invention will be described in detail with reference to FIGS. 2 and 3.

Referring first to FIG. 2, the heat management system of the present invention further includes an increased diameter portion 30 formed in the refrigerant pipe portion of the refrigerant circulation line 12, which directly affects a refrigerant pressure loss in the refrigerant pipes on the intake and discharge sides of the compressor 12a.

The increased diameter portion 30 is used to eliminate the refrigerant pressure loss occurring in the refrigerant pipes on the intake and discharge sides of the compressor 12a, and is formed in the refrigerant pipe portion of the refrigerant circulation line 12, which directly affects the refrigerant pressure loss in the refrigerant pipes on the intake and discharge sides of the compressor 12a, for example, in the refrigerant pipe portion 40 between the low pressure side heat exchangers 12g and the compressor 12a.

In more detail, the increased diameter portion 30 includes a first enlarged portion 32 formed in a specific section of the refrigerant pipe portion 40 of the refrigerant circulation line 12 between the low pressure side heat exchangers 12g and the compressor 12a.

The first enlarged portion 32 is formed in a specific section of the refrigerant pipe portion 40 between the low pressure side heat exchangers 12g and the compressor 12a extending from a specific pipe portion 42 on the side of the low pressure side heat exchangers 12g to an intake port 12a-1 of the compressor 12a.

The first enlarged portion 32 is formed so that the diameter of the refrigerant pipe in a specific section from the specific pipe portion 42 on the side of the low pressure side heat exchangers 12g to the intake port 12a-1 of the compressor 12a is larger than the diameter of other pipe portions, i.e., the diameter of the pipe portion from the low pressure side heat exchangers 12g to the specific pipe portion 42.

In particular, the diameter of the refrigerant pipe on the side of the intake port 12a-1 of the compressor 12a is larger than the diameter of the refrigerant pipe on the side of the discharge port of the low pressure side heat exchangers 12g.

Therefore, it is possible to compensate for the large pipe resistance caused by the long refrigerant pipe extending from the low pressure side heat exchangers 12g to the compressor 12a.

Thus, the pipe resistance of the refrigerant flowing from the low pressure side heat exchangers 12g to the intake port 12a-1 of the compressor 12a is reduced.

As a result, it is possible to reduce the refrigerant pressure loss occurring in the refrigerant pipe on the intake side of the compressor 12a.

In particular, as can be noted from [Equation 1] below, the pipe pressure loss ΔP is proportional to the square of the refrigerant flow velocity V. Therefore, the smaller the refrigerant flow velocity, the lower the pipe resistance. Further, the pipe pressure loss ΔP is inversely proportional to the cube of the pipe diameter D. Therefore, the larger the pipe diameter, the lower the pipe resistance.

$$Δ P = f \frac{L}{D} \frac{ρ {V}^{2}}{2} = f \frac{L}{D} \frac{{ρ ( \frac{\dot{m}}{ρ A} )}^{2}}{2} \qquad [ Equation 1 ]$$

In Equation 1, ΔP is a pipe pressure loss, f is a pipe friction coefficient, L is a pipe length (mm), D is a pipe diameter (mm), ρ is a fluid density (kg/m2), is a refrigerant flow rate, and V is a refrigerant flow velocity (m/s).

Therefore, in the structure of the present invention in which the diameter of the refrigerant pipe in a specific section on the side of the intake port 12a-1 of the compressor 12a is made larger than the diameter of the remaining section, the pipe diameter is increased and the refrigerant flow velocity is lowered. Therefore, it is possible to reduce the refrigerant pressure loss in the refrigerant pipe on the intake and discharge sides of the compressor 12a.

As a result, it is possible to prevent a decrease in the work output of the compressor 12a due to the refrigerant pressure loss, thereby improving the cooling performance of the air conditioning system 10.

Meanwhile, the first enlarged portion 32 is preferably formed in a section of the refrigerant pipe portion 40 between the low pressure side heat exchangers 12g and the compressor 12a, which extends from a confluence point of the refrigerant pipe 40a on the discharge port side of the front seat low pressure side heat exchanger 12g-1 and the refrigerant pipe 40b on the discharge port side of the rear seat low pressure side heat exchanger 12g-2 to the intake port 12a-1 of the compressor 12a.

In this case, the refrigerant pipe 32a in the first enlarged portion 32, the refrigerant pipe 40a on the side of the front seat low pressure side heat exchanger 12g-1, and the refrigerant pipe 40b on the side of the rear seat low pressure side heat exchanger 12g-2 are connected to each other by a separate connector 50.

The connector 50 includes a connector body 52 and a plurality of connection ports 52a, 52b and 52c.

The connection ports 52a, 52b and 52c include a first connection port 52a to which the refrigerant pipe 40a on the side of the front seat low pressure side heat exchanger 12g-1 is connected, a second connection port 52b to which the refrigerant pipe 40b on the side of the rear seat low pressure side heat exchanger 12g-2 is connected, and a third connection port 52c to which the refrigerant pipe 32a in the first enlarged portion 32 is connected.

In this regard, the diameter d2 of the refrigerant pipe 40a on the side of the front seat low pressure side heat exchanger 12g-1 is larger than the diameter d1 of the refrigerant pipe 40b on the side of the rear seat low pressure side heat exchanger 12g-2, and the diameter d3 of the refrigerant pipe 32a in the first enlarged portion 32 is larger than the diameter d2 of the refrigerant pipe 40a on the side of the front seat low pressure side heat exchanger 12g-1.

Therefore, the first to third connection ports 52a, 52b and 52c of the connector 50 also have different diameters so as to correspond to the diameter of the refrigerant pipe 40b on the side of the rear seat low pressure side heat exchanger 12g-2, the diameter of the refrigerant pipe 40a on the side of the front seat low pressure side heat exchanger 12g-1, and the diameter of the refrigerant pipe 32a in the first enlarged portion 32, respectively.

The first enlarged portion 32 has a larger diameter than other pipe portions, i.e., the portion extending from the low pressure side heat exchangers 12g to the specific pipe portion 42, and preferably has a size of 110% to 131% of the diameter of other pipe portions of the refrigerant pipe.

In particular, the first enlarged portion 32 preferably has a size of 110.5% of the diameter d2 of the refrigerant pipe 40a on the side of the front seat low pressure side heat exchanger 12g-1.

In this regard, the diameter d2 of the refrigerant pipe 40a on the side of the front seat low pressure side heat exchanger 12g-1 is set to be larger than the diameter d1 of the refrigerant pipe 40b on the side of the rear seat low pressure side heat exchanger 12g-2, and preferably has a size of 118% to 119% of the diameter d1 of the refrigerant pipe 40b on the side of the rear seat low pressure side heat exchanger 12g-2.

Preferably, the diameter of the refrigerant pipe in the first enlarged portion 32 is Ø21 mm, and the diameter of the refrigerant pipe on the side of the low pressure side heat exchanger 12g is Ø16 mm or Ø19 mm.

Referring again to FIG. 2, the increased diameter portion 30 further includes a second enlarged portion 34 formed in a specific section of the refrigerant pipe 60 of the refrigerant circulation line 12 between the discharge port 12a-2 of the compressor 12a and the high pressure side heat exchanger 12b.

The second enlarged portion 34 is formed in the entire section or a specific section of the refrigerant pipe 60 between the discharge port 12a-2 of the compressor 12a and the high pressure side heat exchanger 12b.

The second enlarged portion 34 is formed so that the diameter of the entire section or a specific section of the refrigerant pipe 60 between the discharge port 12a-2 of the compressor 12a and the high pressure side heat exchanger 12b is larger than the diameter of other pipe portions, for example, the diameter of the refrigerant pipe of the dehumidification line 14, which is branched from the downstream side of the rear end of the heat pump mode expansion valve 12c and connected to the upstream side of the front seat low pressure side heat exchanger 12g-1.

Therefore, the pipe resistance of the refrigerant flowing from the discharge port 12a-2 of the compressor 12a to the high pressure side heat exchanger 12b is reduced, thereby reducing the refrigerant pressure loss due to the pipe resistance on the discharge side of the compressor 12a.

As a result, it is possible to prevent a decrease in the work output of the compressor 12a due to refrigerant pressure loss, thereby improving the cooling performance of the air conditioning system 10.

In some cases, the second enlarged portion 34 may be configured to have a diameter larger than the diameter of the refrigerant pipe on the inlet and outlet sides of the air-cooled outdoor heat exchanger 12e.

Meanwhile, the diameter of the refrigerant pipe 60 in the second enlarged portion 34 is significantly larger than the diameter of other pipe portions, i.e., the diameter of the refrigerant pipe in the dehumidification line 14, and may preferably be 177% to 178% of the diameter of the refrigerant pipe in the dehumidification line 14.

The diameter of the refrigerant pipe 60 in the second enlarged portion 34 is larger than the diameter of the refrigerant pipe in the dehumidification line 14, and is preferably smaller than the diameter of the refrigerant pipe 32a in the first enlarged portion 32.

Preferably, the diameter of the refrigerant pipe 60 in the second enlarged portion 34 is preferably smaller than the diameter of the refrigerant pipe 32a in the first enlarged portion 32 by 76 to 77%.

More preferably, the diameter of the refrigerant pipe in the second enlarged portion 34 is Ø16 mm.

Referring again to FIG. 2, the increased diameter portion 30 further includes a third enlarged portion 36 formed in a specific section of the refrigerant pipe 70 of the refrigerant circulation line 12 between the high pressure side heat exchanger 12b and the water-cooled outdoor heat exchanger 12d.

The third enlarged portion 36 is formed in the entire section or a specific section of the refrigerant pipe 70 between the high pressure side heat exchanger 12b and the water-cooled outdoor heat exchanger 12d.

The third enlarged portion 36 is formed so that the diameter of the entire section or a specific section of the refrigerant pipe 70 between the high pressure side heat exchanger 12b and the water-cooled outdoor heat exchanger 12d is larger than the diameter of other pipe portions, for example, the diameter of the refrigerant pipe of the dehumidification line 14, which is branched from the downstream side of the rear end of the heat pump mode expansion valve 12c and connected to the upstream side of the front seat low pressure side heat exchanger 12g-1.

Therefore, the pipe resistance of the refrigerant flowing from the high pressure side heat exchanger 12b to the water-cooled outdoor heat exchanger 12d is reduced, thereby reducing the refrigerant pressure loss due to the pipe resistance on the discharge side of the compressor 12a.

As a result, it is possible to prevent a decrease in the work output of the compressor 12a due to refrigerant pressure loss, thereby improving the cooling performance of the air conditioning system 10.

In some cases, the third enlarged portion 34 may be configured to have a diameter larger than the diameter of the refrigerant pipe on the inlet and outlet sides of the air-cooled outdoor heat exchanger 12e.

Meanwhile, the diameter of the refrigerant pipe 70 in the third enlarged portion 36 is significantly larger than the diameter of other pipe portions, i.e., the diameter of the refrigerant pipe in the dehumidification line 14, and may preferably be 177% to 178% of the diameter of the refrigerant pipe in the dehumidification line 14.

The diameter of the refrigerant pipe 70 in the third enlarged portion 36 is larger than the diameter of the refrigerant pipe in the dehumidification line 14, and is preferably smaller than the diameter of the refrigerant pipe 32a in the first enlarged portion 32.

Preferably, the diameter of the refrigerant pipe 70 in the third enlarged portion 36 is preferably smaller than the diameter of the refrigerant pipe 32a in the first enlarged portion 32 by 76 to 77%.

More preferably, the diameter of the refrigerant pipe in the third enlarged portion 36 is Ø16 mm.

According to the vehicular heat management system of the present invention having such a configuration, the increased diameter portion 30 is formed in the refrigerant pipe portions on the intake and discharge sides of the compressor 12a so that the refrigerant pipe portions on the intake and discharge sides of the compressor have a larger diameter than other pipe portions, thereby reducing the refrigerant pipe resistance generated in the refrigerant pipe portions on the intake port 12a-1 and discharge port 12a-2 sides of the compressor 12a.

In particular, regardless of the length of the refrigerant pipe, it is possible to reduce the pipe resistance of the refrigerant generated in the refrigerant pipe portions on the intake port 12a-1 and discharge port 12a-2 sides of the compressor 12a.

In addition, since the pipe resistance of the refrigerant generated in the refrigerant pipe portions on the intake port 12a-1 and discharge port 12a-2 sides of the compressor 12a can be reduced, it is possible to reduce the refrigerant pressure loss on the intake and discharge sides of the compressor 12a due to the pipe resistance of the refrigerant.

In addition, since the refrigerant pressure loss on the intake and discharge sides of the compressor 12a can be reduced, it is possible to prevent a decrease in the work output of the compressor due to the refrigerant pressure loss, thereby improving the cooling performance of the air conditioning system.

As can be seen in the p-h diagram of FIG. 3, in the related art, a large difference t1 occurs between the refrigerant pressure during refrigerant compression A-B and the refrigerant pressure during refrigerant condensation B-C, resulting in a large refrigerant pressure loss.

However, when the increased diameter portion 30 is formed in the refrigerant pipe portions on the intake and discharge sides of the compressor 12a as in the present invention, a difference t2 hardly occurs between the refrigerant pressure during refrigerant compression A-B and the refrigerant pressure during refrigerant condensation B-C, hardly resulting in a refrigerant pressure loss.

Consequently, according to the present invention in which the increased diameter portion 30 is formed in the refrigerant pipe portions on the intake and discharge sides of the compressor 12a, unlike the related art having no increased diameter portion 30, the pipe resistance and the refrigerant pressure loss due to the pipe resistance do not occur.

As a result, the cooling performance of the air conditioning system 10 can be improved by preventing a decrease in the work output of the compressor 12a due to the refrigerant pressure loss.

While the preferred embodiment of the present invention has been described above, the present invention is not limited to the above-described embodiment. Various modifications and changes may be made without departing from the scope and spirit of the present invention defined in the claims.

The invention claimed is:

1. A vehicular heat management system, comprising:
a refrigerant circulation line including a compressor, a high pressure side heat exchanger, a heat pump mode expansion valve, an outdoor heat exchanger, and a plurality of low pressure side heat exchangers installed parallel to each other, wherein the refrigerant circulation line further includes a refrigerant pipe having an increased diameter portion formed by increasing the diameter of a specific refrigerant pipe portion among a plurality of refrigerant pipe portions affecting a refrigerant pressure in the refrigerant pipe portions on the intake and discharge sides of the compressor so that the specific refrigerant pipe portion has a larger diameter than other refrigerant pipe portions.

2. The system of claim 1, wherein the increased diameter portion includes a first enlarged portion formed in a specific section of the refrigerant pipe of the refrigerant circulation line between the low pressure side heat exchangers and the compressor, and the first enlarged portion is formed so that the diameter of the refrigerant pipe portion on the intake port side of the compressor is larger than the diameter of the refrigerant pipe portions on the discharge port sides of the low pressure side heat exchangers.

3. The system of claim 2, wherein the first enlarged portion is formed in a specific section of each of the refrigerant pipe portions between the low pressure side heat exchangers and the compressor that extends from the specific refrigerant pipe portion on the side of the low pressure side heat exchangers to an intake port of the compressor.

4. The system of claim 3, wherein the refrigerant pipe portions on the discharge port sides of the low pressure side heat exchangers are joined at a confluence point, and the first enlarged portion is formed is a section extending from the confluence point to the intake port of the compressor.

5. The system of claim 4, further comprising:
a connector configured to connect the refrigerant pipe portions on the side of the first enlarged portion to the refrigerant pipe portions on the side of the low pressure side heat exchangers,
wherein the connector has first and second connection ports to which the refrigerant pipe portions on the side of the low pressure side heat exchangers are connectable, and a third connection port to which the refrigerant pipe portion on the side of the first enlarged portion is connectable.

6. The system of claim 5, wherein the diameter of the refrigerant pipe in the first enlarged portion is Ø21 mm, and the diameter of the refrigerant pipe on the side of each of the low pressure side heat exchangers is Ø16 or Ø19 mm.

7. The system of claim 6, wherein the low pressure side heat exchangers include two of a front seat low pressure side heat exchanger, a rear seat low pressure side heat exchanger, and a battery-cooling low pressure side heat exchanger.

8. The system of claim 2, wherein the increased diameter portion further includes a second enlarged portion formed in a specific section of the refrigerant pipe of the refrigerant circulation line between a discharge port of the compressor and the high pressure side heat exchanger.

9. The system of claim 8, wherein the second enlarged portion is formed in the entire section or a specific section of the refrigerant pipe between the discharge port of the compressor and the high pressure side heat exchanger,
the system further comprises a dehumidification line branched from a rear end of the heat pump mode expansion valve and connected to the low pressure side heat exchangers, and
the second enlarged portion is formed to have a larger diameter than a refrigerant pipe of the dehumidification line.

10. The system of claim 9, wherein the increased diameter portion further includes a third enlarged portion formed in a specific section of the refrigerant pipe of the refrigerant circulation line between the high pressure side heat exchanger and the outdoor heat exchanger.

11. The system of claim 10, wherein the third enlarged portion is formed in the entire section or a specific section of the refrigerant pipe between the high pressure side heat exchanger and the outdoor heat exchanger,
the system further comprises a dehumidification line branched from a rear end of the heat pump mode expansion valve and connected to the low pressure side heat exchangers, and
the third enlarged portion is formed to have a larger diameter than a refrigerant pipe of the dehumidification line.

12. The system of claim 11, wherein the diameter of the refrigerant pipe in the second enlarged portion and the third enlarged portion is smaller than the diameter of the refrigerant pipe in the first enlarged portion.

13. The system of claim 12, wherein the diameter of the second enlarged portion and the third enlarged portion is Ø16 mm.
